(19) United States
(12) Patent Application Publication
(10) Pub. No.: US 2019/0094355 A1
(43) Pub. Date: Mar. 28, 2019

(54) OCCUPANT DETECTION APPARATUS

(71) Applicant: DENSO CORPORATION, Kariya-city, Aichi-pref. (JP)

(72) Inventor: Hajime NAKAGAWA, Kariya-city, Aichi-pref. (JP)

(21) Appl. No.: 16/079,351

(22) PCT Filed: Oct. 21, 2016
(86) PCT No.: PCT/JP2016/081203

§ 371 Date: Aug. 23, 2018

(30) Foreign Application Priority Data
Feb. 26, 2016 (JP) 2016-35287

(51) Int. Cl. G01S 15/04; B60R 21/015; G01S 15/08

(52) U.S. Cl. CPC G01S 15/04; G01S 15/08; B60R 21/01536

(57) ABSTRACT

An occupant detection apparatus includes a wave motion sensor and an controller. The wave motion sensor provided to be upper than the seat in the vehicle, performing transmission of wave motion towards a predetermined range which includes a head part of the occupant at least, performing reception of the wave motion that is reflected. The controller calculates, as a result value, at least either a first value or a second value based on the transmission and the reception of the wave motion by the wave motion sensor; the first value is a receiving intensity and the second value is either a period of time or a distance. The controller determines either (i) that the seat is occupied by the occupant or (ii) that the seat is empty or occupied by a physical body other than the occupant, based on comparison of the result value with a threshold value.

### CROSS REFERENCE TO RELATED APPLICATION

The present application is based on Japanese Patent Application No. 2016-35287 filed on Feb. 26, 2016, the disclosure of which is incorporated herein by reference.

### TECHNICAL FIELD

The present disclosure relates to an occupant detection apparatus which detects whether an occupant is seated on a seat in a vehicle.

### BACKGROUND ART

Conventionally, Patent literature 1 discloses a technology related to an occupant detection apparatus having an object to distinguish easily a baggage and a human being from each other with a simple principle configuration. This occupant detection apparatus includes a sound wave generator and a sound wave receiver. A presence of an occupant is detected based on a variation in an output from the sound wave receiver according to the movement of the physical body.

### PRIOR ART LITERATURES

### Patent Literature

Patent literature 1: JP H09-295552 A

### SUMMARY OF INVENTION

Note that if the technology in Patent literature 1 is employed, a physical body needs to move to bend forward within a generating range of stationary waves for distinguishing a baggage and a human being from each other. The number of stationary waves do not change by a physical body failing to move or a physical body moving differently from bending forward (for example, a physical body moving to bend sideways) in the generating range of the stationary waves. The technology in Patent literature 1 thus poses a possibility of failing to distinguish a baggage and a human being from each other.

The present disclosure is made in consideration of such a possibility. It is an object of the present disclosure to provide an occupant detection apparatus enabled to detect whether or not a seat is occupied by an occupant (i.e, enabled to distinguish a baggage and a human being from each other).

To achieve the object, according to a first aspect of the present disclosure, an occupant detection apparatus that detects whether an occupant is seated on a seat in a vehicle is provided to include a wave motion sensor and a determiner section. The wave motion sensor is provided to be upper than the seat in the vehicle, performing transmission of a wave motion towards a predetermined range which includes a head part of the occupant at least, performing reception of the wave motion that is reflected. The determiner section determines the seat being occupied by the occupant in response to that one of or both of a period of time and a distance obtained based on the transmission and the reception of the wave motion by the wave motion sensor are equal to or less than a threshold value; the determiner section determines the seat being empty or occupied by a physical body other than the occupant in response to that one of or both of the period of time and the distance are greater than the threshold value.

This configuration may allow the determination whether a seat is occupied by an occupant based on the distance or the period of time (or receiving intensity) from when generating the wave motion towards a predetermined range including the occupant's head to when detecting the wave motion reflected. Therefore, even if the occupant does not move, the occupant may be distinguished from a baggage.

According to a second aspect of the present disclosure, an occupant detection apparatus that detects whether an occupant is seated on a seat in a vehicle is provided to include a wave motion scanning sensor, a scanning information producer section, and a determiner section. The wave motion scanning sensor is provided to be on an upper side and a front side of the seat in the vehicle, performing scanning and transmission of a wave motion in a predetermined range which includes at least a predetermined part of the occupant, performing reception of the wave motion that is reflected. The scanning information producer section produces first scanning information based on the scanning and the reception of the wave motion by the wave motion scanning sensor. The determiner section determines either (i) the seat being occupied by the occupant or (ii) the seat being empty or occupied by a physical body other than the occupant, based on the first scanning information produced by the scanning information producer section.

Under this configuration, the first scanning information is produced based on the wave motion which is generated towards a predetermined range including a head part of an occupant and is detected, and determines whether the seat is occupied by the occupant by determining whether the first scanning information includes the information indicating the occupant. Therefore, even if the occupant does not move, the occupant may be distinguished from a baggage.

Note that the “vehicle” is just required to allow at least one occupant to ride on such as an automobile; the kind of power for the vehicle is not limited or the number of wheels for the vehicle is not limited. The “seat” may include a driver seat, a passenger seat, or a rear seat; the number of seats is not limited or the shape of the seat is not limited. The “occupant” is a human being regardless of an adult or a child; however, the “occupant” may include an animal seated on a seat such as a dog or a cat. The “wave motion sensor” or “wave motion scanning sensor” may be any sensor which can detect using wave motions; usually, the “wave motion sensor” or “wave motion scanning sensor” includes a transmitter emitting wave motions towards a physical body and a receiver receiving the wave motion reflected from the physical body. The “wave motion sensor” corresponds to a sound wave sensor or an optical sensor. The sound wave sensor may use an ultrasonic wave sensor using an ultrasonic wave or a sonic wave sensor using a sonic wave other than an ultrasonic wave. The optical sensor includes an electromagnetic wave sensor, a visible light sensor, an infrared sensor, and a radar sensor. The infrared sensor may include a radiation thermometer not needing a generation source. The “wave motion scanning sensor” is a sensor configured to scan using a sound wave sensor or an optical sensor. The “first scanning information” may be any information produced based on the wave motion which is generated by the wave motion scanning sensor and is detected. The “second scanning information” may be any information produced based on the wave motion which is generated and scanned by the wave motion scanning sensor and is detected. The “first scanning information” or the “second scanning information” may be any information indicating at least one of a distance, a period of time, or a receiving intensity, such as a file, a database, a map, or an image.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram illustrating an example of a first configuration of a vehicle;

FIG. 2 is a schematic diagram illustrating an example of a first configuration of an occupant detection apparatus;

FIG. 3 is a side view illustrating schematically an example of a first detection of an occupant;

FIG. 4 is a plan view illustrating schematically an example of a first detection of an occupant;

FIG. 5 is a flowchart diagram illustrating an example of a first sequence of an occupant detection process;

FIG. 6 is a graph illustrating schematically an association among a receiving intensity, a distance, and a period of time;

FIG. 7 is a schematic diagram illustrating an example of a second configuration of a vehicle;

FIG. 8 is a schematic diagram illustrating an example of a second configuration of an occupant detection apparatus;

FIG. 9 is a side view illustrating schematically an example of a second detection of an occupant;

FIG. 10 is a plan view illustrating schematically an example of a second detection of an occupant;

FIG. 11 is a flowchart diagram illustrating an example of a second sequence of an occupant detection process;

FIG. 12 is a schematic diagram illustrating an example of second scanning information relating to an occupant;

FIG. 13 is a schematic diagram illustrating an example of second scanning information relating to a baggage;

FIG. 14 is a schematic diagram illustrating an example of a third configuration of a vehicle;

FIG. 15 is a schematic diagram illustrating an example of second scanning information relating to an occupant;

FIG. 16 is a side view illustrating an example of an arrangement of a wave motion sensor;

FIG. 17 is a schematic diagram illustrating an example of a fourth configuration of a vehicle; and

FIG. 18 is a schematic diagram illustrating an example of a fifth configuration of a vehicle.

### EMBODIMENTS FOR CARRYING OUT INVENTION

Embodiments of the present disclosure will be explained with reference to drawings. Note that “connecting” signifies electrically connecting unless otherwise indicated explicitly. Each drawing illustrates constituent elements necessary for explaining the present disclosure but may not always illustrate all the constituent elements. The directions such as right, left, up, or down are defined based on the illustration in the drawings. The alphanumeric consecutive signs are abbreviated using the symbol “to.” For example, “the seats 11 to 14” signifies “the seats 11, 12, 13, 14,” A capital letter and a small letter of English character of a sign signifies mutually different elements. For example, the first scanning information P1a, P1b and the first scanning information P1A, P1B are mutually different elements. The region where a sensor is arranged may include a roof, a pillar, a dashboard, an instrument panel, or a center console, is a region that faces a vehicle interior in the vehicle.

Note that “information,” which may be used not only as an uncountable noun but also a countable noun, is equivalent to an informational item. One information is equivalent to one informational item; a plurality of informations are equivalent to a plurality of informational items. Further, “data” is used also as one data or a plurality of data. One data is equivalent to one data item; a plurality of data are equivalent to a plurality of data items.

### First Embodiment

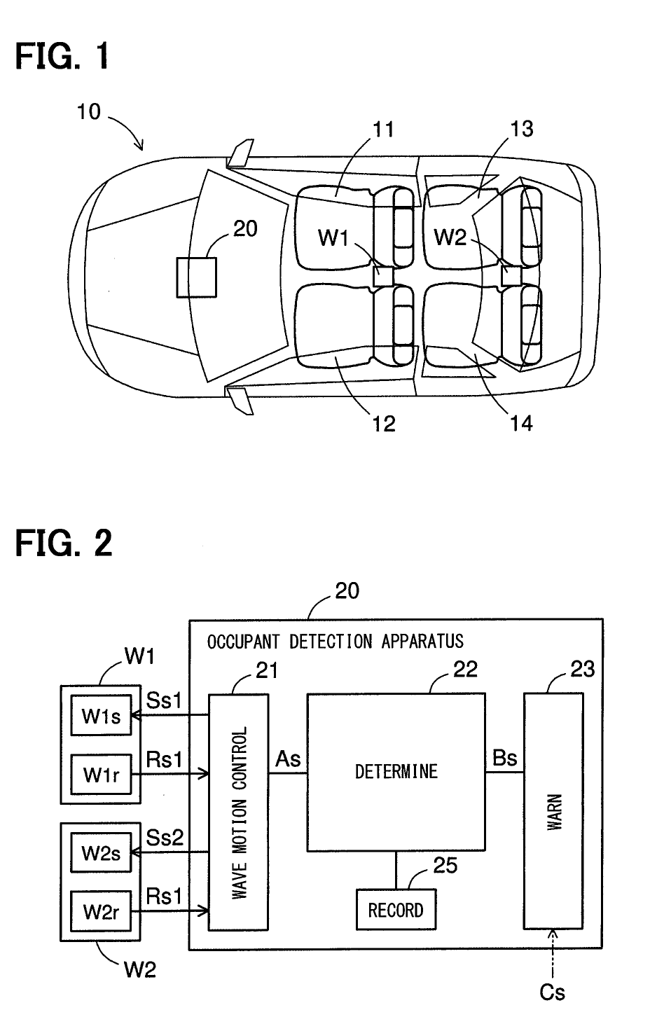

A first embodiment is an example of detecting an occupant using a wave motion sensor, and is explained with reference to FIG. 1 to FIG. 6. FIG. 1 illustrates a vehicle 10 including seats 11 to 14, wave motion sensors W1, W2, and an occupant detection apparatus 20.

The wave motion sensor W1, W2 is a sensor which transmits a wave motion towards a predetermined range which includes a head part of an occupant at least, and receive a reflected wave motion. The wave motion sensor W1 includes a transmitter W1s which transmits a wave motion, and a receiver W1r which receives a reflected wave motion. The wave motion sensor W2 includes a transmitter W2s which transmits a wave motion, and a receiver W2r which receives a reflected wave motion. The wave motion sensor W1, W2 uses a sound wave sensor; the wave motion uses a sound wave. The predetermined range will be explained in detail later.

The wave motion sensor W1, W2 according to the present embodiment is arranged in a central position in a lateral direction (a vertical direction in FIG. 1) in the vehicle 10. That is, the wave motion sensor W1 is arranged in a position between the seat 11 and the seat 12. The wave motion sensor W2 is arranged in a position between the seat 13 and the seat 14.

The occupant detection apparatus 20 illustrated in FIG. 2 employs a controller such as an ECU (Electronic Control Unit) or a computer, for example. The occupant detection apparatus 20 according to the present embodiment uses an ECU to include a wave motion controller section 21, a determiner section 22, a warning section 23, and a recorder 25.

The wave motion controller section 21 performs measurement with the wave motion sensor W1, W2, when the detection condition mentioned later is satisfied. For example, the wave motion controller section 21 transmits a transmit signal Ss1 to the wave motion sensor W1, and receives a reception signal Rs1 from the wave motion sensor W1 which receives the reflected wave motion. Similarly, the wave motion controller section 21 transmits a transmit signal Ss2 to the wave motion sensor W2, and receives a reception signal Rs2 from the wave motion sensor W2 which receives the reflected wave motion. The wave motion controller section 21 outputs, as a measurement signal, at least one of a receiving intensity, a distance, and a period of time from when the wave motion sensor W1, W2 transmits a wave motion to when the wave motion sensor W1, W2 receives the reflected wave motion. The distance is calculated based on the frequency of the wave motion and the period of time from when the wave motion sensor W1, W2 transmits the wave motion to when the wave motion sensor W1, W2 receives the reflected wave motion.

The determiner section 22 determines whether a seat is occupied by an occupant based on the measurement signal As transmitted from the wave motion controller section 21, and outputs a determination result Bs. For example, when at least one of a period of time, a distance, and a receiving intensity included in the measurement signal As is equal to or less than a threshold value, it is determined that a seat 11 to 14 is occupied by an occupant; when at least one is greater than the threshold value, it is determined that the seat 11 to 14 is empty or occupied by a physical body other than an occupant. As long as an occupant is distinguished, such a threshold value may be changed as needed. One or more values are recorded in the recorder 25 as this threshold value.

The warning section 23 performs a necessary warning including a determination signal Bs transmitted from the determiner section 22. For example, on condition that the determination signal Bs includes the information on determining that the seat is occupied by an occupant, a warning such as “fastening the seat belt” is presented. Furthermore, on condition that the information indicating that a seatbelt signal Cs illustrated with two-dot chain line in FIG. 2 includes the information indicating that a seat belt is not fastened, a warning may be presented. Such a warning may be presented with respect to each of the seats 11 to 14.

A warning may be achieved, as needed, such as an image via a display apparatus or a sound or a speech via a sound apparatus. The display apparatus includes a liquid crystal display, an EL display apparatus, an LED, or a lamp. The sound apparatus includes a speaker or a buzzer. The display apparatus or the sound apparatus may be replaced by an instrument panel, a center console, or a navigation apparatus, which is provided in the vehicle 10.

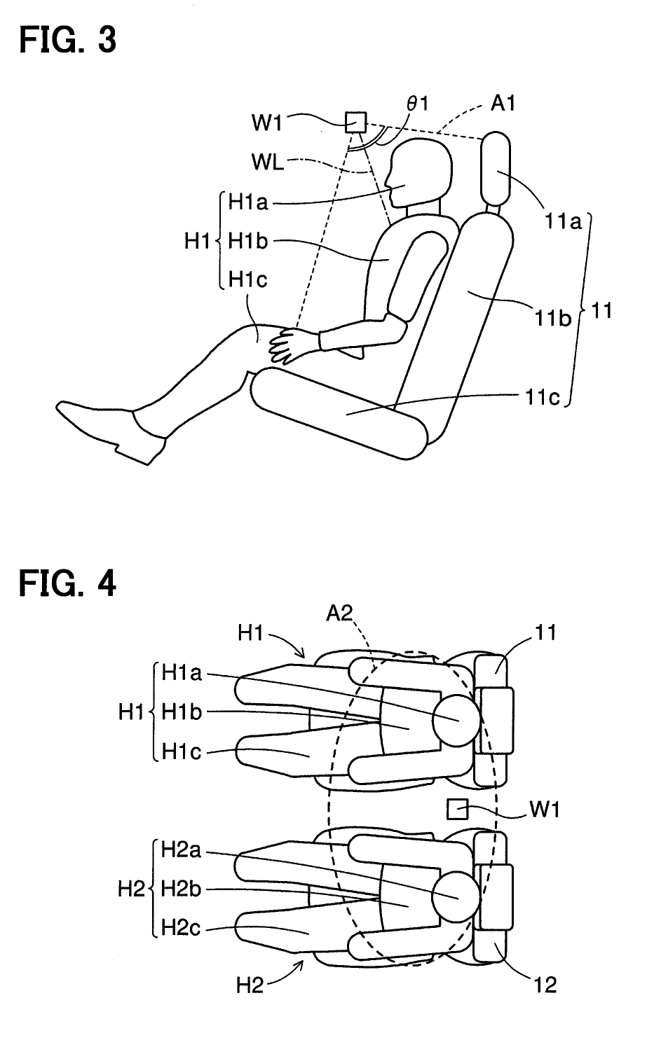

The predetermined range where the wave motion transmitted by the wave motion sensor W1, W2 propagates is illustrated in FIG. 3 and FIG. 4. Note that each of the wave motion sensors W1 W2 is arranged in a central position in a lateral direction in the vehicle 10; FIG. 3 and FIG. 4 illustrate the wave motion sensor W1 as a representative. Although the wave motion sensor W1 detects an occupant who is seated on each of the seat 11 and the seat 12, FIG. 3 illustrates the seat 11 as a representative. The occupant H1, H2 illustrated in FIG. 3 and FIG. 4 simulate a standard physique of an adult occupant.

The predetermined range Al illustrated in FIG. 3 with the broken line is a range where the wave motion WL propagates in a vertical direction in the vehicle 10 with an angle θ1. The predetermined range A1 and the angle θ1 are designated according to a performance or a specification of the wave motion sensor W1. The wave motion sensor W1 designates a predetermined range A1 so as to include a head part H1a of the occupant H1 at least. Furthermore, the predetermined range A1 may be designated so as to include a trunk part H1b or a leg part H1c of the occupant H1. The wave motion sensor W1 is arranged in a position upper than the seat 11 in the vehicle 10. The basis for “upper than the seat 11” may be set as needed. The present embodiment sets the basis at the headrest 11a, but may set the basis at the back rest 11b or the seating surface 11c. In the example in FIG. 3, the wave motion sensor W1 is arranged on a roof in the vehicle 10, but may be arranged on a pillar (unshown) in the vehicle 10.

The predetermined range A2 illustrated in FIG. 4 with the broken line is a range where the wave motion WL propagates in the lateral direction (vertical direction in FIG. 4) in the vehicle 10. The predetermined range A2 is designated according to a performance or a specification of the wave motion sensor W1. The wave motion sensor W1 designates a predetermined range A2 so as to include at least a head part H1a of the occupant H1 and a head part H2a of the occupant H2. Furthermore, the predetermined range A2 may be designated so as to include the trunk part H1b or the leg part H1c of the occupant H1 and the trunk part H2b or the leg part H2c of the occupant H2.

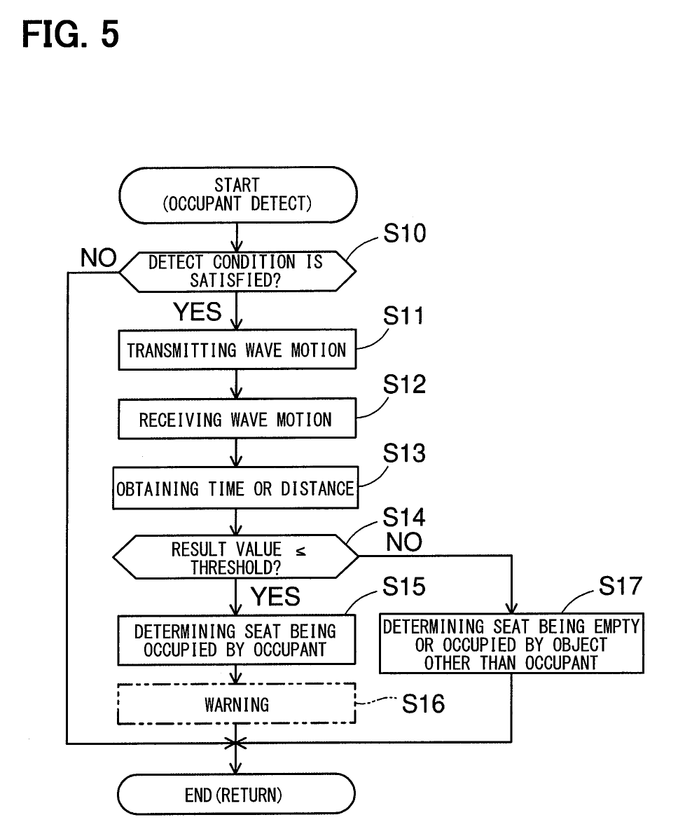

The occupant detection process performed by the occupant detection apparatus 20 mentioned above is explained with reference to FIG. 5. It is further noted that the described flowchart includes sections (also referred to as steps), which are represented, for instance, as S10. Further, each section can be divided into several sections while several sections can be combined into a single section. Each section may be referred to as a device or a specific name, or with a structure modification; for instance, a seat determiner section may be also referred to as a seat determiner device or a seat determiner. Further, each section can be achieved not only (i) as a software section in combination with a hardware unit (e.g., computer), but also (ii) as a hardware circuit (e.g., integrated circuit, hard-wired logic circuit), including or not including a function of a related apparatus. Further, the hardware section may be inside of a microcomputer.

The occupant detection process is executed repeatedly while the occupant detection apparatus 20 operates. In FIG. 5, S11 and S12 are equivalent to a wave motion controller section 21; S13 to S15, and S17 are equivalent to a determiner section (or seat determiner section) 22; and S16 is equivalent to a warning section (safety warning section) 23. Ending of the occupant detection process includes returning to execute another process.

The occupant detection process is performed individually depending on the combination between the wave motion sensors W1, W2 and the seats 11 to 14. The following explains an example of detecting an occupant with respect to the combination between the wave motion sensor W1 and the seat 11.

At S10, it is determined whether the detection condition is satisfied. Any detection condition may be employed as needed as long as it is to detect an occupant seated on a seat, such as the power switch of the vehicle 10 turning on, the opening and closing switch of a door of the vehicle 10 turning on or off, or the running speed of the vehicle 10 exceeding 0 Km/h. Any one condition or a plurality of conditions may be designated. The “power switch” includes an ignition switch. When the detection condition is satisfied (S10: YES), the sequence proceed to S11. In contrast, when the detection condition is not satisfied (S10: NO), the occupant detection process is ended.

At S11, the wave motion sensor W1 transmits a wave motion WL. At S12, the wave motion sensor W1 receives a reflected wave motion WL. At S13, one of or both of a period of time and a distance is obtained. The period of time is from when the wave motion WL is transmitted to when the wave motion WL is received; the distance is from the wave motion sensor W1 to the occupant H1. The reception of the wave motion WL at S12 may include the reception of a receiving intensity. The period of time, the distance, or the receiving intensity is equivalent to a result value and recorded in the recorder 25.

At S14, the sequence branches depending on the relation between the result value and the threshold value. The threshold value is designated according to the result value. When the result value is equal to or greater than the threshold value (i.e., result value ≥ threshold value) (S14: YES), the sequence proceed to S15. In contrast, when the result value is less than the threshold value (i.e., result value < threshold value) (S14: NO), the sequence proceed to S17.

At S15, it is determined that the occupant Hi is seated on the seat 11. At S16, a warning is presented as needed. If the seatbelt signal Cs illustrated with two-dot chain line in FIG. 2 includes the information indicating that a seat belt is not fastened (i.e., when a seatbelt is not fastened), a warning may be presented. Then, the occupant detection process is then ended.

In contrast, at S17, it is determined that a physical body other than an occupant H1 is seated on the seat 11, or it is determined that the seat 11 is empty. Then, the occupant detection process is then ended.

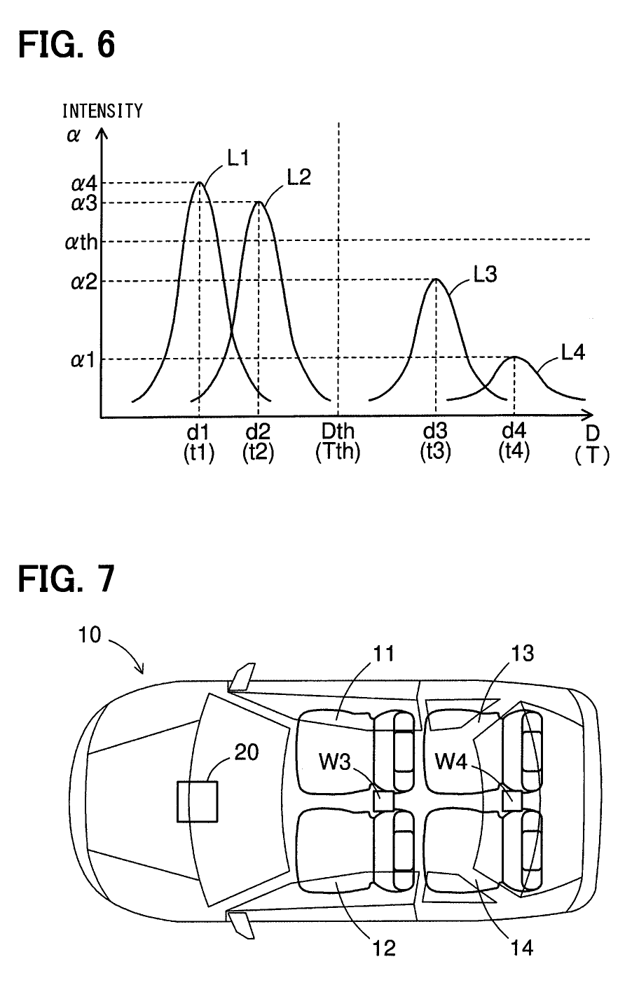

FIG. 6 illustrates examples of determination at S14 in FIG. 5. The receiving intensity α illustrated on the axis of ordinate is a receiving intensity of the wave motion WL received by the receiver W1r, W2r. The characteristic line L1 illustrates an example where an adult occupant H1 is seated on the seat 11, and the receiving intensity α4 exhibits a peak value at the distance d1. The characteristic line L2 illustrates an example where a child or pet occupant H1 is seated on the seat 11, and the receiving intensity α3 exhibits a peak value at the distance d2. The characteristic line L3 illustrates an example where a baggage is present on the seat 11, and the receiving intensity α2 exhibits a peak value at the distance d3. The characteristic line L4 illustrates an example where the seat 11 is empty, and the receiving intensity α1 exhibits a peak value at the distance d4.

The period of time T in the parenthesis indicates the case where the period of time is obtained at S13 in FIG. 5. In this case, the period of time t1 corresponds to the distance d1, the period of time t2 corresponds to the distance d2, the period of time t3 corresponds to the distance d3, and the period of time t4 corresponds to the distance d4.

At S14 in FIG. 5, the threshold value is designated so as to determine either (i) the seat 11 being occupied by an adult or child occupant H1 or (ii) the seat 11 being empty or occupied by a physical body. For example, the distance threshold value Dth is designated to be between the distance d2 and the distance d3. The period of time threshold Tth is designated to be between the period of time t2 and the period of time t3. The intensity threshold value ath is designated to be between the receiving intensity α2 and the receiving intensity α3.

With FIG. 5 and FIG. 6, an example is explained which detects an occupant with respect to the combination between the wave motion sensor W1 and the seat 11. The similar explanation to detect an occupant may be applied to the combination between the wave motion sensor W1 and the seat 12, the combination between the wave motion sensor W2 and the seat 13, or the combination between the wave motion sensor W2 and the seat 14. In the combination of the wave motion sensor W1 and the seat 12, the similar explanation is applied by replacing the seat 11 with the seat 12. In the combination of the wave motion sensor W2 and the seat 13, the similar explanation is applied by replacing the wave motion sensor W1 with the wave motion sensor W2, and replacing the seat 11 with the seat 13. In the combination of the wave motion sensor W2 and the seat 14, the similar explanation is applied by replacing the wave motion sensor W1 with the wave motion sensor W2, and replacing the seat 11 with the seat 14. Thereby, the detection of an occupant is performed with respect to all the seats 11 to 14.

The above first embodiment provides advantageous effects as follows.

(1) The occupant detection apparatus 20 includes a wave motion sensor W1, W2, and a determiner section 22, as illustrated in FIG. 1 and FIG. 2. As illustrated in FIG. 3 and FIG. 4, the wave motion sensor W1, W2 is provided at a position in the vehicle 10 to be upper than the seat 11 to 14, and transmits the wave motion WL towards a predetermined range A1, A2 including the head part H1a, H2a of the occupant H1, H2 and receives the reflected wave motion WL. As illustrated in FIG. 6, the determiner section 22 determines that the seat 11 to 14 is occupied by an occupant H1, H2 in response to that at least one of a period of time T, a distance D, and a receiving intensity a based on transmission and reception of the wave motion WL by the wave motion sensor W1, W2 is equal to or less than a threshold value (e.g., a distance threshold value Dth, a period of time threshold value Tth, an intensity threshold value ath). In contrast, the determiner section 22 determines that the seat 11 to 14 is empty or is occupied by a physical body other than an occupant H1, H2 in response to that the at least one is greater than the threshold value. This configuration may allow the determination whether the seat 11 to 14 is occupied by an occupant H1, H2 based on the receiving intensity a, the distance D, or the period of time T from when the wave motion is transmitted towards a predetermined range A1, A2 including the head part H1a, H2a of the occupant H1, H2 to when the reflected wave motion WL is received. Therefore, even if the occupant H1, H2 does not move, the occupant H1, H2 may be distinguished from a baggage. That is, even if a physical body does not move or moves in the direction other than the forward direction, it may be determined whether such a physical body is an occupant H1, H2 or not.

(2) As illustrated in FIG. I and FIG. 4, the wave motion sensor W1, W2 is provided in a central position in the lateral direction in the vehicle 10. The wave motion sensor W1 corresponds to the seat 11, 12, located on the right side and on the left side of the central position. The wave motion sensor W2 corresponds to the seat 13, 14 located on the right side and on the left side of the central position. The determiner section 22 performs the determination with respect to the seats 11 to 14. This configuration allows the use of one wave motion sensor W1, W2 to determine whether each of a plurality of seats is occupied by an occupant.

### Second Embodiment

A second embodiment is an example of detecting an occupant using a wave motion scanning sensor, and is explained with reference to FIG. 7 to FIG. 13. Note that in order to simplify the illustration in the drawing and the description, the same element as that in the first embodiment is assigned with the same reference sign as that in the first embodiment; thereby, the explanation is omitted. The points which are different from the first embodiment will be therefore explained mainly.

FIG. 7 illustrates the vehicle 10 including seats 11 to 14, wave motion scanning sensors W1, W2, and an occupant detection apparatus 20. The vehicle 10 illustrated in FIG. 7 differs from the vehicle 10 illustrated in FIG. 1 in respect of replacing the wave motion sensor W1, W2 with the wave motion scanning sensor W3, W4. The wave motion scanning sensor W3, W4 uses a sound wave sensor; the wave motion uses a sound wave.

The wave motion scanning sensor W3, W4 is a sensor which scans and transmits a wave motion towards a predetermined range which includes a head part of an occupant at least, and receives a reflected wave motion. The wave motion scanning sensor W3 includes a transmitter W3s which scans and transmits a wave motion, and a receiver W3r which receives a reflected wave motion. The wave motion scanning sensor W4 includes a transmitter W4s which scans and transmits a wave motion, and a receiver W4r which receives a reflected wave motion. The predetermined range which is scanned will be explained in detail later.

The wave motion scanning sensor W3, W4 according to the present embodiment is arranged in a central position in a lateral direction (a vertical direction in FIG. 7) in the vehicle 10. The wave motion scanning sensor W3 is arranged in a position between the seat 11 and the seat 12. The wave motion scanning sensor W4 is arranged in a position between the seat 13 and the seat 14.

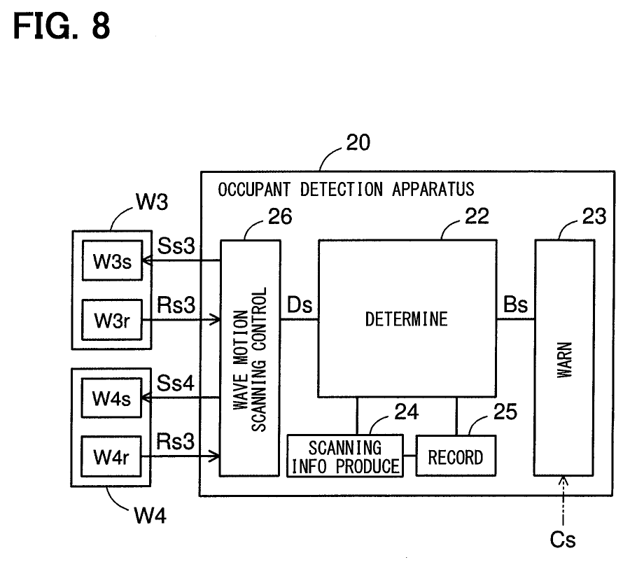

As illustrated in FIG. 8, the occupant detection apparatus 20 includes a wave motion scanning controller section 26, a determiner section 22, a warning section 23, a scanning information producer section 24, and a recorder 25. The wave motion scanning controller section 26 performs scanning measurement with the wave motion scanning sensors W3, W4, when the detection condition mentioned later is satisfied. For example, the wave motion scanning controller section 26 transmits a transmit signal Ss3 to the wave motion scanning sensor W3, and receives a reception signal Rs3 from the wave motion scanning sensor W3 which receives the reflected wave motion. Similarly, the wave motion scanning controller section 26 transmits a transmit signal Ss4 to the wave motion scanning sensor W4, and receives a reception signal Rs4 from the wave motion scanning sensor W4 which receives the reflected wave motion. The wave motion scanning controller section 26 outputs, as a measurement signal Ds, the distance from the wave motion scanning sensor W3, W4 to a physical body. The distance is calculated based on the frequency of the wave motion or the period of time from when the wave motion scanning sensor W3, W4 transmits the wave motion to when the wave motion scanning sensor W3, W4 receives the reflected wave motion.

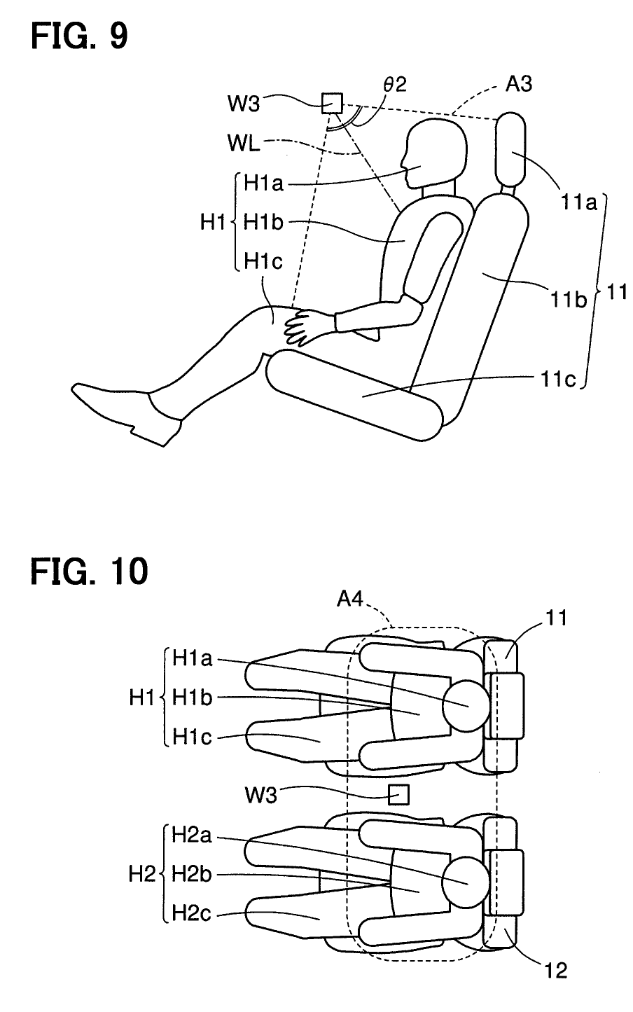

The predetermined range where the wave motion transmitted by the wave motion sensor W3, W4 propagates is illustrated in FIG. 9 and FIG. 10. Note that the wave motion scanning sensor W3, W4 is arranged in a central position in a lateral direction in the vehicle 10; FIG. 9 and FIG. 10 illustrate the wave motion scanning sensor W3 as a representative. Although the wave motion scanning sensor W3 detects an occupant who is seated on each of the seat 11 and the seat 12, FIG. 9 illustrates the seat 11 as a representative.

The predetermined range A3 illustrated in FIG. 9 with the broken line is a range where the wave motion WL is scanned to propagate in a vertical direction in the vehicle 10 with an angle θ2. The predetermined range A3 and the angle θ2 are designated according to a performance or a specification of the wave motion scanning sensor W3. The wave motion scanning sensor W3 designates a predetermined range A1 so as to include a head part H1a of the occupant H1 at least. The wave motion scanning sensor W3 is arranged in a position on the upper side and the front side of the seat 11 in the vehicle 10. The basis for “on the upper side and the front side of the seat 11″ may be designated as needed. The headrest 11a is used for the basis in the present embodiment; otherwise, the back rest 11b or the seating surface 11c may be used for the basis. In the example of FIG. 9, the wave motion scanning sensor W3 is arranged on a roof in the vehicle 10, but may be arranged on a pillar (unshown) in the vehicle 10. The “front side” signifies a forward direction in which the vehicle 10 advances.

The predetermined range A4 illustrated in FIG. 10 with the broken line is a range where the wave motion WL propagates in a lateral direction (vertical direction in FIG. 10) in the vehicle 10. The predetermined range A4 is designated according to a performance or a specification of the wave motion scanning sensor W3. The wave motion scanning sensor W3 designates a predetermined range A4 so as to include a head part H1a of the occupant H1 and a head part H2a of the occupant H2 at least.

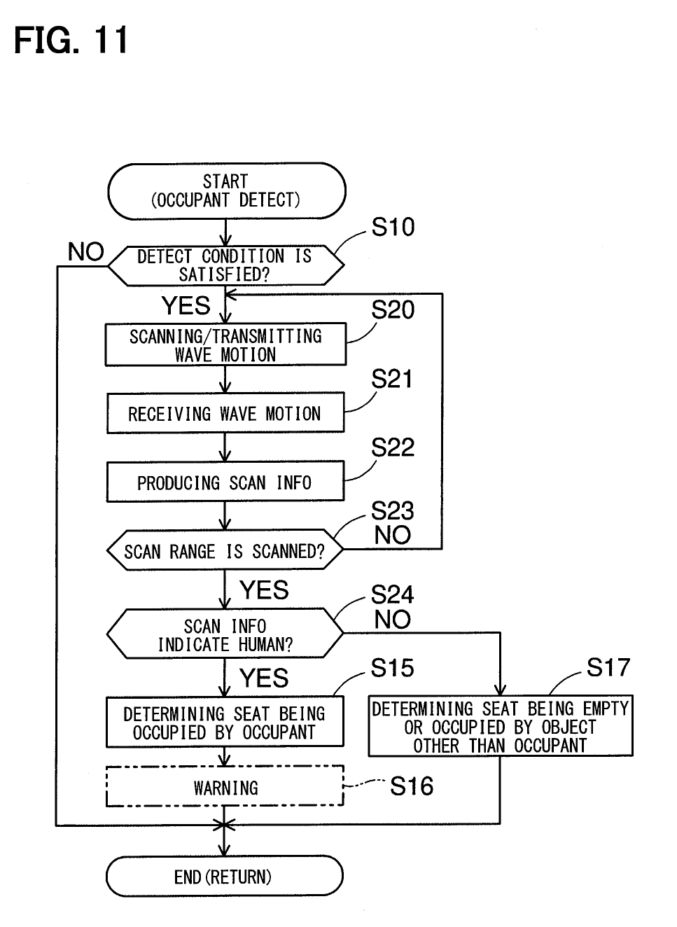

The occupant detection process performed by the occupant detection apparatus 20 mentioned above is explained with reference to FIG. 11. The occupant detection process is executed repeatedly while the occupant detection apparatus 20 operates. In FIG. 11, S20 and S21 are equivalent to a wave motion controller section 21; S22 is equivalent to a scanning information producer section 24; and S23, S24, S15, and S17 are equivalent to a determiner section 22.

The occupant detection process is performed individually depending on the combinations between the wave motion scanning sensors W3, W4 and the seats 11 to 14. The following explains an example of detecting an occupant with respect to the combination between the wave motion scanning sensor W3 and the seat 11.

At S20, the wave motion scanning sensor W3 scans and transmits a wave motion WL. At S21, the wave motion scanning sensor W3 receives a reflected wave motion WL. The reception of the wave motion WL at S21 may include the reception of a receiving intensity. At S22, the first scanning information is produced based on the wave motion WL scanned and received by the wave motion scanning sensor W3, and is recorded on the recorder 25. The first scanning information is a data aggregate which indicates the distance from the wave motion scanning sensor W3 to the occupant H1, such as a table, a map, or a database.

At S23, the sequence branches depending on whether all the scanning range corresponding to the predetermined range A3, A4 mentioned above are scanned. The modes (e.g., a scanning direction, a measurement count at one scanning, or a measurement interval) of scanning in a scanning range may be designated as needed according to a performance or a specification of the wave motion scanning sensor W3 or a magnitude of the predetermined range A3, A4. When all the scanning range is scanned (S23: YES), the sequence proceeds to S24. In contrast, when all the scanning range is not scanned (S23: NO), S20 to S23 are repeated.

At S24, the sequence branches depending on whether the first scanning information indicates a human being. The first scanning information, which scans the scanning range, provides a two-dimensional data. The “whether the first scanning information indicates a human being” will be explained in detail. When the first scanning information indicates a human being (S24: YES), the sequence proceeds to S15. In contrast, when the first scanning information fails to indicate a human being (S24: NO), the sequence proceeds to S17.

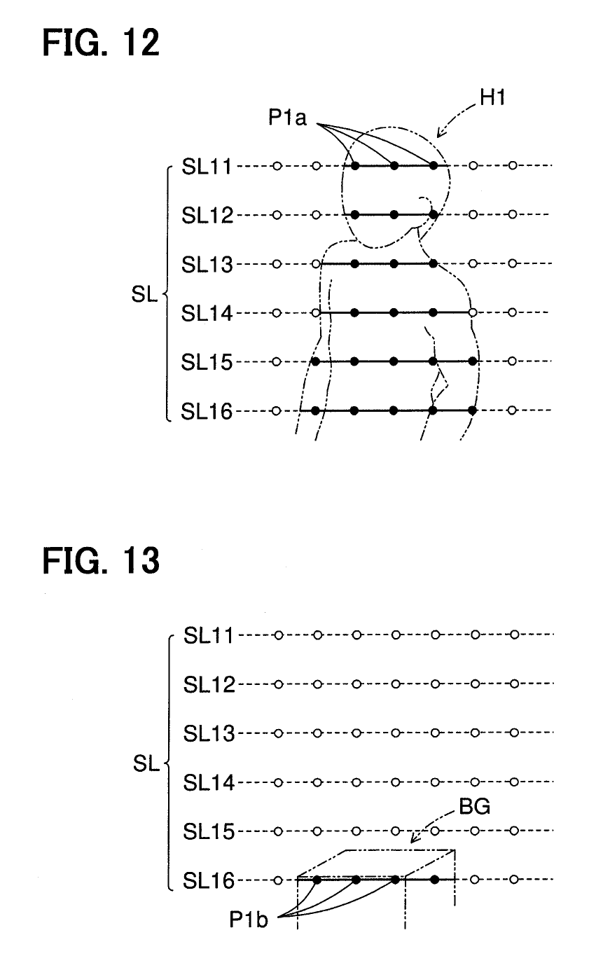

FIG. 12 and FIG. 13 illustrate examples of determination at S24 in FIG. 11. The predetermined range A3, A4 is assumed to include a plurality of scanning lines SL11 to SL16. The number or the interval of scanning lines SL may be designated as needed. In each scanning line SL, a solid line and a black round (i.e., a circle filled with a black color) indicates a portion having a shorter distance up to the wave motion scanning sensor W3; a broken line and a white round (i.e., a circle only with an outline) indicates a portion having a longer distance up to the wave motion scanning sensor W3. The short or longer distance signifies being, respectively, shorter or longer than the distance threshold value Dth in FIG. 6. The black rounds and the white rounds in FIG. 12 and FIG. 13, which are two-dimensional data, are included in the first scanning information.

The first scanning information P1a of the occupant H1 in FIG. 12 provides the scanning lines SL11 to SL16, all of which include black rounds in a plurality of points. The first scanning information P1b in FIG, 13 provides the scanning lines SL11 to SL16, of which only the scanning line SL16 includes black rounds. Whether the occupant H1 is seated on the seat 11 is thus determined based on the first scanning information P1a, P1b providing the data related to the distance up to the wave motion scanning sensor W3.

In addition, the first scanning information P1A related to a standard occupant H1 illustrated in FIG. 12 with two-dot chain lines or the first scanning information P1A related to a baggage BG illustrated in FIG. 13 with two-dot chain lines may be recorded in the recorder 25. In addition, the occupant H1 illustrated in FIG. 12 is simulated as a model of an adult; another first scanning information P1B simulated as a model of a child may be recorded in the recorder 25. The first scanning information P1A, P1B is not limited to the above, but may be simulated using a data model such as an outline, a wire frame, or a solid data model. At S24 in FIG. 11, the first scanning information P1a, P1b based on the measurement using the wave motion scanning sensor W3 is compared with the first scanning information P1A, P1B so as to determine whether an occupant H1 is seated on the seat 11 by determining whether a predetermined multiple number of points of agreements is found. In this way, whether the seat 11 is occupied by an occupant H1 or the seat 11 is empty or occupied by a physical body other than an occupant H1 is determined based on the first scanning information P1, P1A, P1B providing two-dimensional data.

With FIG. 11 to FIG. 13, an example is explained which detects an occupant with respect to the combination between the wave motion scanning sensor W3 and the seat 11. The similar determination of an occupant may be enabled with respect to the combination between the wave motion scanning sensor W3 and the seat 12, the combination between the wave motion scanning sensor W4 and the seat 13, or the combination between the wave motion scanning sensor W4 and the seat 14. In the combination of the wave motion scanning sensor W3 and the seat 12, the similar explanation is applied by replacing the seat 11 with the seat 12. In the combination of the wave motion scanning sensor W4 and the seat 13, the similar explanation is applied by replacing the wave motion scanning sensor W3 with the wave motion scanning sensor W4, and replacing the seat 11 with the seat 13. In the combination of the wave motion scanning sensor W4 and the seat 14, the similar explanation is applied by replacing the wave motion scanning sensor W3 with the wave motion scanning sensor W4, and replacing the seat 11 with the seat 14. Thereby, the detection of an occupant is performed with respect to all the seats 11 to 14.

The above second embodiment provides advantageous effects as follows.

(3) The occupant detection apparatus 20 includes wave motion scanning sensors W3, W4, a scanning information producer section 24, and a determiner section 22, as illustrated in FIG. 7 and FIG. 8. The wave motion scanning sensor W3, W4 scans and transmits the wave motion WL at least within a predetermined range A3, A4 including a predetermined part of an occupant H1, H2, as illustrated in FIG. 9 and FIG. 10, and receives the reflected wave motion WL. The scanning information producer section 24 produces the first scanning information Pia, Pib as illustrated in FIG. 12 and FIG. 13 based on the wave motion WL scanned and received by the wave motion scanning sensor W3, W4. The determiner section 22 determines either (i) each of the seats 11 to 14 being occupied by an occupant or (ii) each of the seats 11 to 14 being empty or occupied by a baggage BG other than the occupant H1, H2 based on the first scanning information P1a, P1b produced by the scanning information producer section 24. According to this configuration, the first scanning information P1a, P1b is produced based on the wave motion WL which is transmitted towards the predetermined range A1, A2 including the head part H1a, H2a of the occupant H1, H2, and is received; whether the seat 11 to 14 is occupied by an occupant H1, H2 by determining whether the first scanning information Pla, Pib includes the information indicating an occupant. Therefore, even if the occupant does not move, the occupant may be distinguished from a baggage BG. That is, even if a physical body does not move or moves in the direction other than the forward direction, it may be determined whether such a physical body is an occupant H1, H2 or not.

(4) As illustrated in FIG. 7 and FIG, 10, the wave motion scanning sensor W3, W4 is provided in a central position in a lateral direction in the vehicle 10. The determiner section 22 performs the determination with respect to the seats 11 to 14 located on a right side and on a left side of the central position. The wave motion scanning sensor W3 corresponds to the seat 11 and the seat 12, respectively, located on the right side and on the left side of the central position. The wave motion scanning sensor W4 corresponds to the seat 13 and the seat 14, respectively, located on the right side and on the left side of the central position. This configuration allows the use of one wave motion scanning sensor W3, W4 to determine whether each of a plurality of seats is occupied by an occupant.

### Third Embodiment

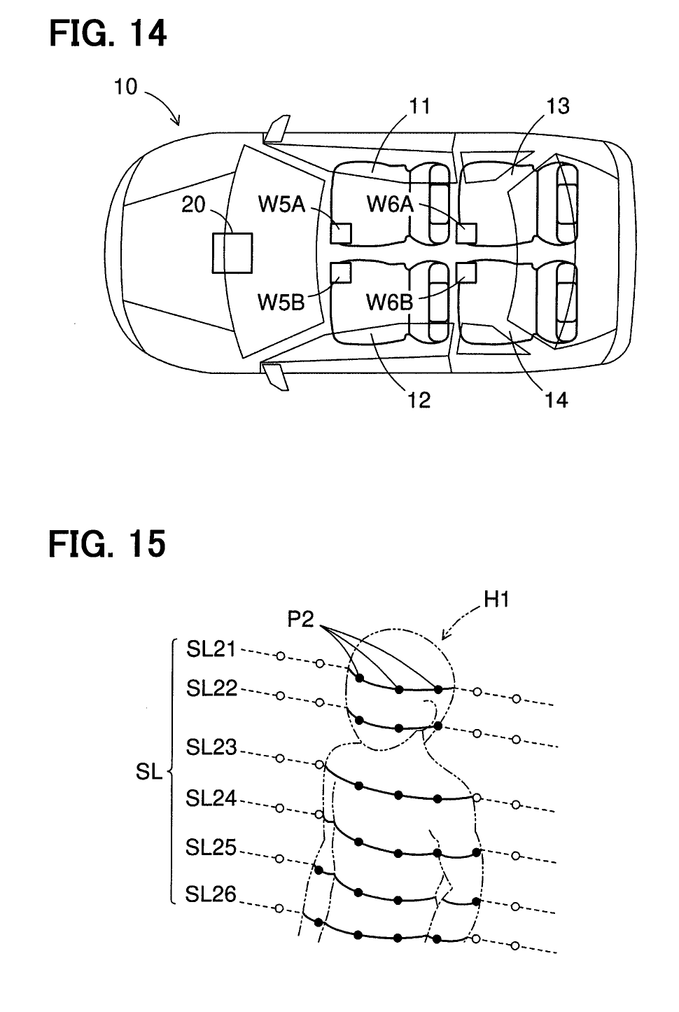

A third embodiment is an example of detecting an occupant using a plurality of wave motion scanning sensors, and is explained with reference to FIG. 14 and FIG. 15. Note that in order to simplify the illustration in the drawing and the description, the same element as that in the second embodiment is assigned with the same reference sign as that in the second embodiment; thereby, the explanation is omitted. The points which are different from the second embodiment will be thereby explained mainly.

FIG. 14 illustrates the vehicle 10 including seats 11 to 14, wave motion scanning sensors W5A, W5B, W6A, W6B, and an occupant detection apparatus 20. The vehicle 10 illustrated in FIG. 14 differs from the vehicle 10 illustrated in FIG. 7 in respect of replacing the wave motion scanning sensors W3, W4 with the wave motion scanning sensors W5A, W5B, W6A, W6B. A plurality of wave motion scanning sensors W5A, W5B are equivalent to the wave motion scanning sensor W3. A plurality of wave motion scanning sensors W6A, W6B are equivalent to the wave motion scanning sensor W4. The wave motion scanning sensor W5A, W5B, W6A, W6B uses a sound wave sensor; the wave motion uses a sound wave.

The occupant detection apparatus 20 (unshown) has the same configuration as that in FIG. 8. The occupant detection apparatus 20 differs from that illustrated in FIG. 8 in respect of replacing the wave motion scanning sensors W3, W4 with the wave motion scanning sensors W5A, W5B, W6A, W6B. Note that the wave motion scanning sensor W5A, W5B and the wave motion scanning sensor W6A, W6B are different from each other in respect of the arranged position, but they are equivalent in respect of operations. The following thus explains the wave motion scanning sensor W5A, W5B as a representative.

The occupant detection process performed by the occupant detection apparatus 20 is similar to that in FIG. 11. They are different in respect of S22 producing the second scanning information, and S24 branching depending on whether the second scanning information indicates a human being.

The wave motion scanning sensor W5A, W5B measures the information that is a two-dimensional data as illustrated in FIG. 12 and FIG. 13, individually. The wave motion scanning sensor W5A and the wave motion scanning sensor W5B are arranged in previously designated positions that are mutually different from each other in the vehicle 10 with an inter-sensor distance between them (e.g., several millimeters or several centimeters). The two-dimensional data produced based on the information measured by the wave motion scanning sensor W5A thus differs from the two-dimensional data produced based on the information measured by the wave motion scanning sensor W5B. The two-dimensional data measured by the wave motion scanning sensor W5A and the two-dimensional data measured by the wave motion scanning sensor W5B are used to obtain a three-dimensional data of a physical body that reflects the wave motion. The calculation of a three-dimensional position, which corresponds to a three-dimensional image process by a stereo system, for instance, is a known technology; thus, the drawing and description are omitted. The produced second scanning information, which is a data aggregate indicating a three dimensional position of the physical body, corresponds to a table, a map, or a database,

FIG. 15 illustrates an example of the determination at S24 in FIG. 11 as to whether the second scanning information indicates a human being. The predetermined range A3, A4 is assumed to include a plurality of scanning lines SL21 to SL26. The number or the interval of scanning lines SL may be designated as needed. The black rounds and the white rounds in FIG. 15 are equivalent to those in FIG. 12 and FIG. 13, except that those are three dimensional data included in the second scanning information. The following explains an example of detecting an occupant with respect to the combination between the wave motion scanning sensor W5A, W5B and the seat 11.

The second scanning information P2 of an occupant H1 in FIG. 15 provides the scanning lines SL21 to SL26, all of which include black rounds in a plurality of points. The second scanning information P2 (unshown) in FIG. 13 provides the scanning lines SL21 to SL26, only some of which include black rounds. A human being and a baggage are different from each other in respect of the three dimensional position reflecting the wave motion WL. Whether an occupant H1 is seated on the seat 11 is thus determined based on the second scanning information P2 providing a three-dimensional data.

In addition, the second scanning information P2A related to a standard occupant H1 illustrated with the two-dot chain lines may be recorded in the recorder 25. In addition, the occupant H1 illustrated in FIG. 15 uses an adult as a model; the second scanning information P2B using a child as a model may be recorded in the recorder 25. The second scanning information P2A, P2B is not limited to the above, but may be simulated using a data model such as an outline, a wire frame, or a solid data model. At S24 in FIG. 11, the second scanning information P2 based on the measurement using the wave motion scanning sensor W5A, W5B is compared with the second scanning information P2A, P2B so as to determine whether an occupant H1 is seated on the seat 11 by determining whether a predetermined multiple number of points of agreements is found. In this way, whether the seat 11 is occupied by an occupant H1 or the seat 11 is empty or occupied by a physical body other than an occupant H1 is determined based on the second scanning information P2, P2A, P2B providing three-dimensional data.

With FIG. 15, an example is explained which detects an occupant with respect to the combination between the wave motion scanning sensors W5A, W5B and the seat 11. The similar determination of an occupant may be enabled with respect to the combination between the wave motion scanning sensors W5A, W5B and the seat 12, the combination between the wave motion scanning sensors W6A, W6B and the seat 13, or the combination between the wave motion scanning sensor W6A, W6B and the seat 14. In the combination of the wave motion scanning sensors W5A, W5A and the seat 12, the similar explanation is applied by replacing the seat 11 with the seat 12. In the combination of the wave motion scanning sensors W6A, W6B and the seat 13, the similar explanation is applied by replacing the wave motion scanning sensors W5A, W5B with the wave motion scanning sensors W6A, W6B, and replacing the seat 11 with the seat 13. In the combination of the wave motion scanning sensors W6A, W6B and the seat 14, the similar explanation is applied by replacing the wave motion scanning sensors W5A, W5B with the wave motion scanning sensors W6A, W6B, and replacing the seat 11 with the seat 14. Thereby, the detection of an occupant is performed with respect to all the seats 11 to 14.

The third embodiment can provide advantageous effects similar to those of the second embodiment while providing the following advantageous effects.

(5) The occupant detection apparatus 20 includes a plurality of wave motion scanning sensors W5A, W5B, W6A, W6B, and a determiner section 22, as illustrated in FIG. 14 and FIG. 15. The scanning information producer section 24 produces the second scanning information P2 based on a plurality of wave motions WL which are scanned and received by a plurality of wave motion scanning sensors W5A, W5B, W6A, W6B. The determiner section 22 determines either (i) the seat 11 to 14 being occupied by an occupant H1, H2 or (ii) the seat 11 to 14 being empty or occupied by a physical body other than an occupant H1, H2 based on the second scanning information P2 produced by the scanning information producer section 24. According to this configuration, a three-dimensional second scanning information P2 is produced based on a plurality of wave motions WL; whether the seat 11 to 14 is occupied by an occupant H1, H2 by determining whether the second scanning information P2 includes the information indicating an occupant H1, H2. This improves an accuracy in determining whether the seat 11 to 14 is occupied by an occupant H1, H2.

The third embodiment provides a configuration including one set of two wave motion scanning sensors W5A, W5B and another one set of two wave motion scanning sensors W6A, W6B. Alternatively, another configuration may be provided which includes a set of at least three wave motion scanning sensors; this provides an advantageous effect similar to that of the third embodiment. If a set of four wave motion scanning sensors is included in the configuration, a three-dimensional positioning may be performed like GPS (global positioning system).

### Fourth Embodiment

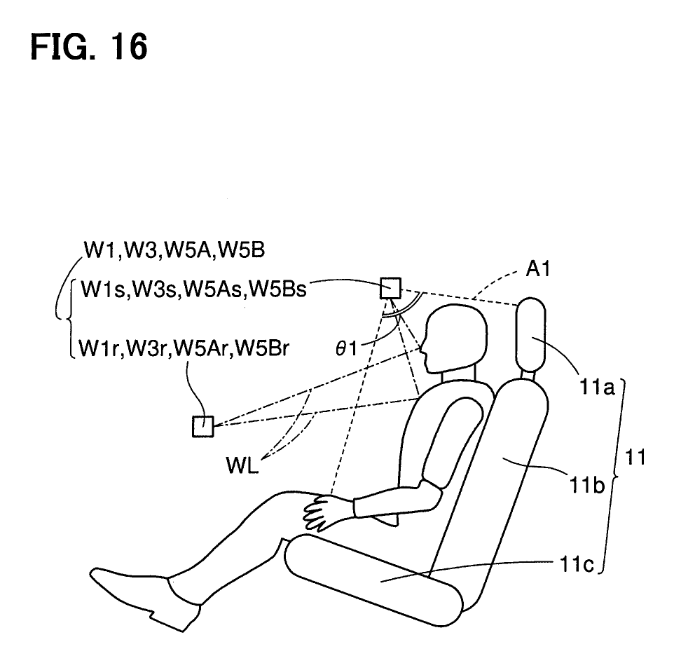

A fourth embodiment is an example of detecting an occupant using a plurality of wave motion scanning sensors, and is explained with reference to FIG. 16. Note that in order to simplify the illustration in the drawing and the description, the same element as that in the first to third embodiments is assigned with the same reference sign as that in the first embodiment; thereby, the explanation is omitted. Therefore, the points which are different from the first to third embodiments will be mainly explained.

The wave motion sensor W1 illustrated in FIG. 16 includes a transmitter W1s and a receiver W1r, which are arranged at mutually different regions in the vehicle 10. FIG. 16 illustrates an example of a configuration where the transmitter W1s is arranged on a roof, and the receiver Mr is arranged in a dashboard, an instrument panel, or a center console. Although none shown, the transmitter W1s may be arranged in a dashboard, an instrument panel, or a center console, and the receiver W1r may be arranged on a roof. Similarly, the wave motion scanning sensor W3, W5A, W5B may includes a transmitter W3s, W5As, W5Bs, and a receiver W3r, W5Ar, W5Br, which are arranged at mutually different regions in the vehicle 10. In any configuration, the wave motion WL transmitted by the transmitter W1s, W3s, W5As, W5Bs is reflected by a physical body (i.e., an occupant or a physical body), and the reflected wave motion WL is received by the receiver W1r, W3r, W5Ar, W5Br.

FIG. 16 illustrates an example of an arrangement of the wave motion sensor W1, or the wave motion scanning sensor W3, W5A, W5B, which detects an occupant H1 who is seated on the seat 11. Although none shown, similarly, the wave motion sensor W1 or the wave motion scanning sensor W3, W5A, W5B, which detects an occupant 112 who is seated on the seat 12 may include a transmitter W1s, W3s, W5As, W5Bs, and a receiver W1r, W3r, W5Ar, W5Br, which are arranged in mutually different regions in the vehicle 10. The same may be applied to an arrangement of the wave motion sensor W2, or the wave motion scanning sensor W4, W6A, W6B, which detects an occupant who is seated on the seat 13, 14 which is a rear seat. Anyway, the wave motion sensor W1, W2 or the wave motion scanning sensor W3, W5A, W5B, W6A, W6B may be used for the measurement and the determination as to whether (i) an occupant is seated or (ii) a physical body other than an occupant is seated or none is seated, with respect to each of the seats 11 to 14.

The fourth embodiment can provide advantageous effects similar to those of the first to third embodiments while providing the following advantageous effects.

(6) The wave motion sensor W1, W2 includes a transmitter W1s, W2s which transmits a wave motion WL, and a receiver W1r, W2r which receives a reflected wave motion WL, as illustrated in FIG. 2. The transmitter W1s, W2s and the receiver W1r, W2r are separately provided in mutually different regions in the vehicle 10, as illustrated in FIG. 16. This configuration allows the transmitter W1s, W2s and the receiver W1r, W2r to be arranged at mutually different regions, thereby increasing the flexibility in the arrangement.

(7) The wave motion scanning sensor W3, W4 includes a transmitter W3s, W4s which scans and transmits a wave motion WL, and a receiver W3r, W4r which receives a reflected wave motion WL, as illustrated in FIG. 8. The transmitter W3s, W4s and the receiver W3r, W4r are separately provided in mutually different regions in the vehicle 10, as illustrated in FIG. 16. Although none shown, similarly, the wave motion scanning sensor W5A, W5B, W6A, W6B includes a transmitter W5As which scans and transmits a wave motion WL, W5Bs, W6As, W6Bs, and a receiver W5Ar, W5Br, W6Ar, W6Br which receives a reflected wave motion WL. The transmitter W5As, W5Bs, W6As, W6Bs, and the receiver W5Ar, W5Br, W6Ar, W6Br are arranged in mutually different regions in the vehicle 10, as illustrated in FIG. 16. Those configurations allows the transmitter W3s, W4s, W5As, W5Bs, W6As, W6Bs, and the receiver W3r, W4r, W5Ar, W5Br, W6Ar, W6Br to be arranged in mutually different regions, thereby increasing the flexibility in the arrangement.

### Other Embodiments

The present disclosure is explained according to the first to fourth embodiments. However, there is no need to be limited thereto. In other words, it can be also performed in a variety of embodiments within a scope of the present disclosure, For example, the following embodiments may be provided.

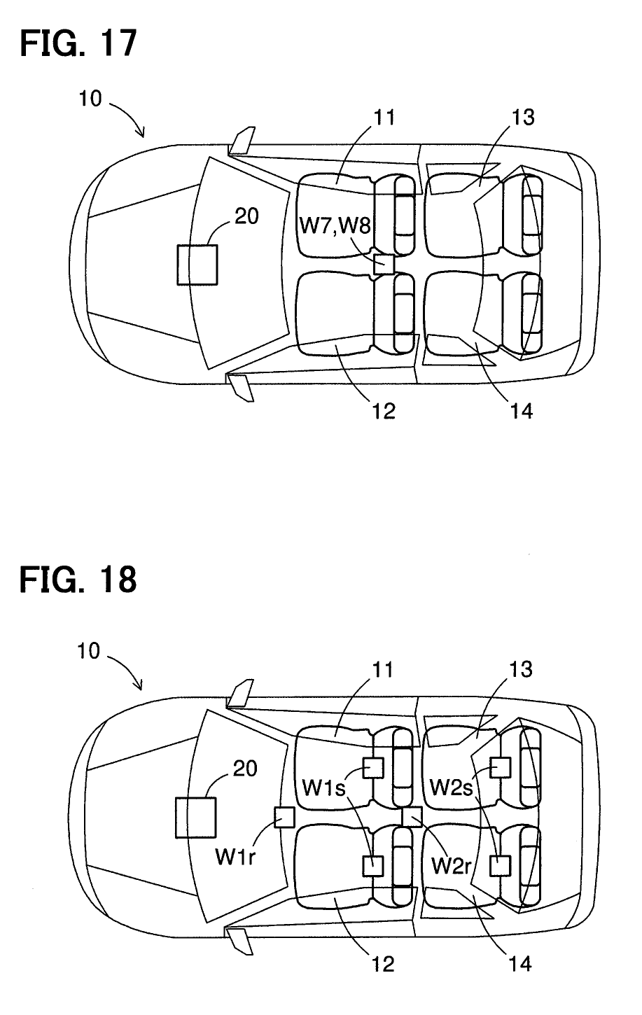

As illustrated in FIG. 1, FIG. 7, and FIG. 14, the above embodiments each provide a configuration where a plurality of wave motion sensors W1, W2 or a plurality of wave motion scanning sensor W3, W4 is included in the vehicle 10. In place of such a configuration, as illustrated in FIG. 17, another configuration may be provided where only one wave motion sensor W7 or only one wave motion scanning sensor W8 is arranged in a central position in a lateral direction of the vehicle 10. Although none shown, another configuration may be provided where a set of wave motion scanning sensors equivalent to the wave motion scanning sensors W5A, W5B is arranged in a central position in a lateral direction of the vehicle 10. The wave motion sensor W7 or the wave motion scanning sensor W8 is provided with a predetermined range A1 to A4 so as to detect an occupant who is seated on each of the seats 11 to 14. Since only the number of the wave motion sensors or wave motion scanning sensors is different, the same advantageous effect as those of the first to fourth embodiments may be provided.

As illustrated in FIG. 2 and FIG. 8, the first to fourth embodiments each provide a configuration where the wave motion sensor W1, W2 or the wave motion scanning sensor W3, W4, W5A, W5B, W6A, W6B includes one transmitter and one receiver. In place of such a configuration, as illustrated in FIG. 18, another configuration may be provided to include a plurality of transmitters W1s and one receiver Win A plurality of transmitters W1s are arranged in mutually different regions in the vehicle 10. Although none shown, the same may be applied to the wave motion sensor W2, or the wave motion scanning sensor W3, W4, W5A, W5B, W6A, W6B. The increase of the number of transmitters allows the position of an occupant to be acquired more accurately. In other aspects, the same advantageous effects as those of the first to fourth embodiments may be provided.

As illustrated in FIG. 1 to FIG. 4, FIG. 7 to FIG. 10, FIG. 14, and FIG. 16, the first to fourth embodiments each provide a configuration where the wave motion sensor W1, W2 or the wave motion scanning sensor W3, W4, W5A, W5B, W6A, W6B uses a sound wave sensor, and the wave motion uses a sound wave. In place of such a configuration, the wave motion sensor W1, W2 or the wave motion scanning sensor W3, W4, W5A, W5B, W6A, W6B uses an optical sensor, and the wave motion uses a light wave (for example, the visible light, infrared light, electric wave). A sound wave sensor and an optical sensor may be used in combination. When a radiation thermometer is used, the radiation temperature of a measured physical body may be used for determining whether (i) an occupant is seated or (ii) a physical body other than an occupant is seated or none is seated. When an optical sensor is used, the same advantageous effects as those of the first to fourth embodiments may be provided.

As illustrated in FIG. 1, FIG. 7, FIG. 14, and FIG. 17, the first to fourth embodiments each provide a configuration where four seats 11 to 14 are included in the vehicle 10. In place of such a configuration, another configuration may be provided where other than four seats are included in the vehicle 10. For example, a sport type vehicle 10 includes two seats; one box type vehicle 10 includes five or more seats; a bus includes tens of seats. Anyway, the wave motion sensor W1, W2 or the wave motion scanning sensor W3, W4, W5A, W5B, W6A, W6B may be arranged according to the number of seats or the arrangement of the seats. The same advantageous effects as those of the first to fourth embodiments may be thereby provided.

As illustrated in FIG. 3, FIG. 4, FIG. 6, FIG. 9, FIG. 10, FIG. 12, FIG. 13, FIG. 15, and FIG. 16, the first to fourth embodiments each provide a configuration where targets for detection are an occupant H1, H2 and a baggage BG. Although none shown, in place of such a configuration, another configuration may be provided where a target for detection is an animal (for example, a dog, a cat) which can be seated on a seat, other than an human being. Since only the target for detection is different, the same advantageous effect as those of the first to fourth embodiments may be provided.

As illustrated in FIG. 1, FIG. 7, FIG. 14, and FIG. 17, the first to fourth embodiments each provide a configuration where the wave motion sensor W1, W2 or the wave motion scanning sensor W3, W5A, W5B, W6A, W6B is provided not to be included in the occupant detection apparatus 20. In place of such a configuration, another configuration may be provided where the wave motion sensor W1, W2 or the wave motion scanning sensor W3, W4, W5A, W5B, W6A, W6B is provided to be included in the occupant detection apparatus 20. Since only the provision of the wave motion sensor W1, W2 or the wave motion scanning sensor W3, W4, W5A, W5B, W6A, W6B is different, the same advantageous effect as those of the first to fourth embodiments may be provided.

As illustrated in FIG. 1, FIG. 7, FIG. 14, and FIG. 17, the first to fourth embodiments each provide a configuration where a four-wheel vehicle is used on which one or more occupants can ride. In place of such a configuration, another configuration may be provided where under the condition where the wave motion sensor W1, W2 or the wave motion scanning sensor W3, W4, W5A, W5B, W6A, W6B is provided along with the occupant detection apparatus 20, a vehicle other than an automobile or another transport machine may be used. For example, a vehicle other than an automobile corresponds to a two-wheel vehicle including a motorcycle, a multi-wheel vehicle including a tractor, or a railroad vehicle. For example, a transport machine corresponds to a transport machine which can convey a human being or a cargo such as an airplane or a marine vessel. In particular, it may be applied to a vehicle or a transport machine needing fastening of a seat belt. Since only the kind of the vehicle to be applied is different, the same advantageous effect as those of the first to fourth embodiments may be provided.

While the present disclosure has been described with reference to embodiments thereof, it is to be understood that the disclosure is not limited to the embodiments and constructions. The present disclosure is intended to cover various modification examples and equivalent arrangements. In addition, the various combinations and configurations, and other combinations and configurations, including more, less or only a single element, are also within the spirit and scope of the present disclosure.

1.-7. (canceled)

8. An occupant detection apparatus that detects whether an occupant is seated on a seat in a vehicle, the occupant detection apparatus comprising:
a wave motion sensor provided to be upper than the seat in the vehicle, the wave motion sensor performing transmission of a wave motion towards a predetermined range which includes a head part of the occupant at least, the wave motion sensor performing reception of the wave motion that is reflected; and
a controller configured
to calculate at least either a first value or a second value as a result value, based on the transmission and the reception of the wave motion by the wave motion sensor, the first value being a receiving intensity, the second value being a period of time or a distance, and
to perform an occupant determination, the occupant determination determining either (i) that the seat is occupied by the occupant or (ii) that the seat is empty or occupied by a physical body other than the occupant, based on comparison of the result value with a threshold value,
wherein:
the wave motion sensor is provided either (i) in a central position in a lateral direction in the vehicle or (ii) in a position between a right seat and a left seat which are located, respectively, on a right side and a left side of the central position in the lateral direction in the vehicle;
the controller is configured to perform the occupant determination with respect to a determination target based on the wave motion by the wave motion sensor, the determination target including a plurality of seats, which are either (i) the right seat and the left seat located, respectively, on the right side and the left side of the central position, or (ii) all seats in the vehicle; and
the predetermined range includes at least a head part of an occupant who is seated on each of the seats included in the determination target.

9. The occupant detection apparatus according to claim 8, wherein:
the wave motion sensor comprises a front wave motion sensor provided on a front side in a longitudinal direction in the vehicle, and a rear wave motion sensor provided on a rear side in the longitudinal direction in the vehicle;
the controller is configured to perform the occupant determination with respect to the determination target which are the right seat and the left seat located on the right side and the left side, respectively, of the central position on the front side in the vehicle, based on the wave motion by the front wave motion sensor; and
the controller is configured to perform the occupant determination with respect to the determination target which are the right seat and the left seat located on the right side and the left side, respectively, of the central position on the rear side in the vehicle, based on the wave motion by the rear wave motion sensor.

10. The occupant detection apparatus according to claim 8, wherein:
the wave motion sensor comprises a front wave motion sensor provided on a front side in a longitudinal direction in the vehicle; and
the controller is configured to perform the occupant determination with respect to the determination target which are all the seats in the vehicle based on the wave motion by the front wave motion sensor.

11. The occupant detection apparatus according to claim 8, wherein:
the wave motion sensor comprises at least one transmitter (W1s, W2s) that performs the transmission of the wave motion, and a receiver (W1r, W2r) that performs the reception of the wave motion reflected; and
the at least one transmitter is provided in a first region in the vehicle and the receiver is provided in a second region in the vehicle, the second region being separate from the first region.

12. An occupant detection apparatus that detects whether an occupant is seated on a seat in a vehicle, the occupant detection apparatus comprising:
a wave motion scanning sensor provided to be on an upper side of the seat and on a front side of the seat in a longitudinal direction in the vehicle, the wave motion scanning sensor performing scanning and transmission of a wave motion in a predetermined range which includes at least a predetermined part of the occupant, the wave motion scanning sensor performing reception of the wave motion that is reflected; and
a controller configured
to produce scanning information based on the scanning, the transmission, and the reception of the wave motion by the wave motion scanning sensor, and
to perform an occupant determination that determines either (i) that the seat is occupied by the occupant or (ii) that the seat is empty or occupied by a physical body other than the occupant, based on the scanning information produced,
wherein:
the wave motion scanning sensor is provided either (i) in a central position in a lateral direction in the vehicle or (ii) in a position between a right seat and a left seat which are located, respectively, on a right side and a left side of the central position in the lateral direction in the vehicle;
the controller is configured to perform the occupant determination with respect to a determination target based on the scanning information produced from the wave motion by the wave motion scanning sensor, the determination target including a plurality of seats, which are either (i) the right seat and the left seat located, respectively, on the right side and the left side of the central position, or (ii) all seats in the vehicle; and
the predetermined range includes at least a head part of an occupant who is seated on each of the seats included in the determination target.

13. The occupant detection apparatus according to claim 12, wherein:
the wave motion scanning sensor comprises a front wave motion scanning sensor provided on a front side in a longitudinal direction in the vehicle, and a rear wave motion scanning sensor provided on a rear side in the longitudinal direction in the vehicle;
the controller is configured to perform the occupant determination with respect to the determination target which are the right seat and the left seat located on the right side and the left side, respectively, of the central position on the front side in the vehicle, based on the scanning information produced from the wave motion by the front wave motion scanning sensor; and
the controller is configured to perform the occupant determination with respect to the determination target which are the right seat and the left seat located on the right side and the left side, respectively, of the central position on the rear side in the vehicle, based on the scanning information produced from the wave motion by the rear wave motion scanning sensor.

14. The occupant detection apparatus according to claim 12, wherein:
the wave motion scanning sensor comprises a front wave motion scanning sensor provided on a front side in a longitudinal direction in the vehicle; and
the controller is configured to perform the occupant determination with respect to the determination target which are all the seats in the vehicle based on the scanning information produced from the wave motion by the front wave motion scanning sensor.

15. The occupant detection apparatus according to claim 12, wherein:
the wave motion scanning sensor comprises at least one transmitter that performs transmission of the wave motion, and a receiver that performs reception of the wave motion that is reflected; and
the at least one transmitter is provided in a first region in the vehicle and the receiver is provided in a second region in the vehicle, the second region being separate from the first region.

16. An occupant detection apparatus that detects whether an occupant is seated on a seat in a vehicle, the occupant detection apparatus comprising:
a wave motion sensor provided to be upper than the seat in the vehicle, the wave motion sensor performing transmission of wave motion towards a predetermined range which includes a head part of the occupant at least, the wave motion sensor performing reception of the wave motion that is reflected; and
a controller configured
to calculate at least either a first value or a second value as a result value based on the transmission and the reception of the wave motion by the wave motion sensor, the first value being a receiving intensity, the second value being a period of time or a distance, and
to perform an occupant determination, the occupant determination determining either (i) that the seat is occupied by the occupant or (ii) that the seat is empty or occupied by a physical body other than the occupant, based on comparison of the result value with a threshold value,
wherein:
the wave motion sensor comprises at least one transmitter that performs the transmission of the wave motion, and a receiver that performs the reception of the wave motion reflected; and
the at least one transmitter is provided in a first range in the vehicle and the receiver is provided in a second range in the vehicle, the second range being separate from the first range.

17. The occupant detection apparatus according to claim 16, wherein:
the controller is provided in a third range in the vehicle, the third range being separate from each of the first range and the second range.

18. The occupant detection apparatus according to claim 16, wherein
the first range is located in front of the second range in a longitudinal direction in the vehicle.

19. The occupant detection apparatus according to claim 16, wherein:
the wave motion sensor is provided in a central position in a lateral direction in the vehicle; and
the controller is configured to perform the occupant determination with respect to the determination target which includes either (i) a right seat and a left seat, respectively, located on a right side and a left side of the central position in the lateral direction, or (ii) all seats in the vehicle.

20. An occupant detection apparatus that detects whether an occupant is seated on a seat in a vehicle, the occupant detection apparatus comprising:
a wave motion scanning sensor provided to be on an upper side of the sea and on a front side of the seat in a longitudinal direction in the vehicle, the wave motion scanning sensor performing scanning and transmission of a wave motion in a predetermined range which includes at least a predetermined part of the occupant, the wave motion scanning sensor performing reception of the wave motion that is reflected; and
a controller configured
to produce scanning information based on the scanning, the transmission, and the reception of the wave motion by the wave motion scanning sensor, and
to perform an occupant determination that determines either (i) that the seat is occupied by the occupant or (ii) that the seat is empty or occupied by a physical body other than the occupant, based on the scanning information produced,
wherein:
the wave motion scanning sensor comprises at least one transmitter that performs the transmission of the wave motion, and a receiver that performs the reception of the wave motion that is reflected; and
the at least one transmitter is provided in a first range in the vehicle and the receiver is provided in a second range in the vehicle, the second range being separate from the first range.

21. The occupant detection apparatus according to claim 20, wherein
the controller is provided in a third range in the vehicle, the third range being separate from each of the first range and the second range.

22. The occupant detection apparatus according to claim 20, wherein:
the first range is located in front of the second range in the longitudinal direction in the vehicle.

23. The occupant detection apparatus according to claim 20, wherein:
the wave motion scanning sensor is provided in a central position in a lateral direction in the vehicle; and
the controller is configured to perform the occupant determination with respect to the determination target which includes either (i) a right seat and a left seat, respectively, located on a right side and a left side of the central position in the lateral direction, or (ii) all seats in the vehicle.

24. The occupant detection apparatus according to claim 20, further comprising:
a plurality of the wave motion scanning sensors, wherein
the controller is configured to produce scanning information based on a plurality of wave motions which are scanned, transmitted, and received by the plurality of wave motion scanning sensors.
